(19) United States
(12) Patent Application Publication
(10) Pub. No.: US 2004/0257681 A1
(43) Pub. Date: Dec. 23, 2004

(54) Bearing arrangement comprising an optical element and a mount

(75) Inventors: Ulrich Weber, Ulm (DE); Armin Schoeppach, Aalen (DE)

Correspondence Address: WELSH & KATZ, LTD, 120 S RIVERSIDE PLAZA, 22ND FLOOR, CHICAGO, IL, 60606, US

(73) Assignee: Carl Zeiss SMT AG, Oberkochen (DE)

(21) Appl. No.: 10/819,044

(22) Filed: Apr. 6, 2004

(30) Foreign Application Priority Data
Apr. 11, 2003 (DE) 103 16 590.8

(51) Int. Cl. G02B 9/06; G02B 7/02

(52) U.S. Cl. 359/819

(57) ABSTRACT

A bearing arrangement comprises an optical element and a mount which are provided, in particular, for a projection objective in microlithography, the optical element being connected to the mount. The optical element and the mount are connected to one another in such a way that owing to a thermally induced expansion of the optical element and/or of the mount a tilting of the optical element relative to the mount results in it being possible to compensate aberrations which occur.

### BACKGROUND OF THE INVENTION

1. Field of the Invention

The invention relates to a bearing arrangement comprising an optical element and a mount.

2. Description of the Related Art

Bearing arrangements which provide a position correction or a tilting of an optical element in conjunction with a temperature change of the projection lens are for example disclosed in U.S. Pat. No. 6,040,950, U.S. Pat. No. 5,283,695 and U.S. Pat. No. 6,594,093.

### SUMMARY OF THE INVENTION

Consequently, it is an object of the invention to create an arrangement of the type mentioned at the beginning which permits a desired tilting of the optical element, and a simple design, in conjunction with heating of an optical element and in accordance with the thermal deformation of a mount.

The object is achieved according to the invention in that the optical element and the mount are connected to one another in such a way that owing to a thermally induced expansion of the optical element and/or of the mount a tilting of the optical element relative to the mount results in it being possible to compensate aberrations which occur.

The starting point is a heating of the optical element by absorption of light passing through in a projection lens, the mount not necessarily being heated, and the aberrations occurring in the process being compensated automatically by means of a specific tilting of the optical element as the function of the thermal deformation, and thus in a way temporally similar to the aberrations occurring.

The optical element and the mount advantageously have coefficients of thermal expansion which are fixed in such a way that tilting of the optical element relative to the mount is possible.

The coefficient of thermal expansion of the optical element and the coefficient of thermal expansion of the mount should be different, since the tilting movement is triggered by the relative change in length upon heating between the optical element and the mount.

Advantageous refinements and developments emerge from the further subclaims and the exemplary embodiments described below in principle with the aid of the drawing, in which:

### BRIEF DESCRIPTION OF THE DRAWINGS

FIG. 1 shows an illustration of the principle with the mode of operation of a projection lens for microlithography having a beam splitter cube;

FIG. 2 shows an illustration of the principle of a first arrangement according to the invention for thermal tilting correction;

FIG. 3 shows an illustration of the principle of a second arrangement according to the invention for thermal tilting correction; and

FIG. 4 shows an illustration of the principle of a further arrangement according to the invention for thermal tilting correction.

FIG. 5 shows an illustration of the principle of an alternatively designed projection lens with a bimirror; and

FIG. 6 shows an illustration of the principle of a further design possibility of a projection lens

### DETAILED DESCRIPTION

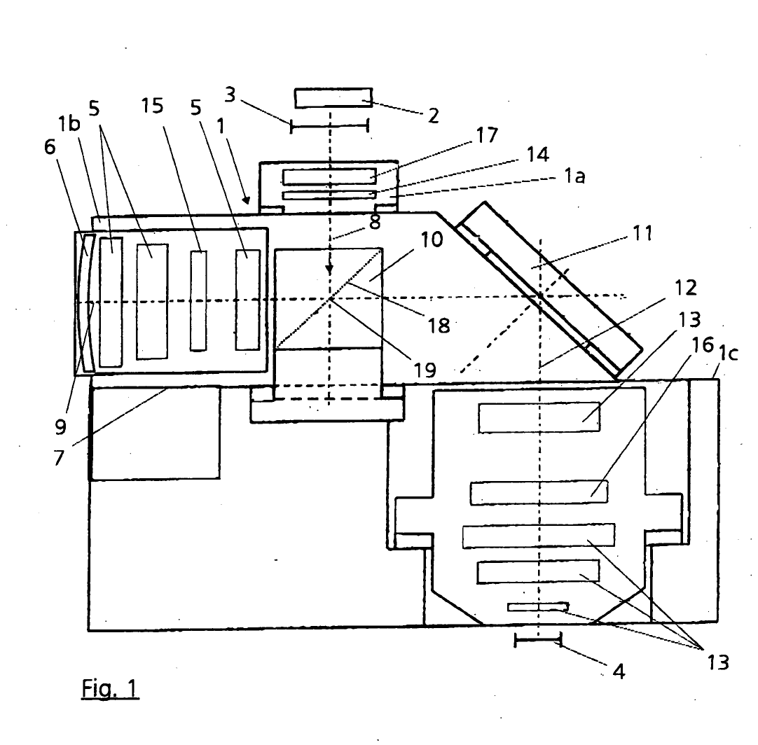

A projection exposure machine having a projection lens 1 for microlithography for producing semiconductor elements is illustrated in FIG. 1 in principle.

It has an illuminating system 2 with a laser (not illustrated) as the light source. Located in the object plane of the projection exposure machine is a reticle 3 whose structure is to be imaged at an appropriately reduced scale onto a wafer 4 which is arranged below the projection lens 1 and is located in the image plane.

The projection lens 1 is provided with a first vertical objective part 1a and a second horizontal objective part 1b. Located in the objective part 1b are a plurality of lenses 5 and a concave mirror 6 which are arranged in an lens housing 7 of the objective part 1b. A beam splitter cube 10 is provided for deflecting the projection beam (see arrow) from the vertical objective part 1a with a vertical optical axis 8 into the horizontal objective part 1b with a horizontal optical axis 9.

After reflection of the beams at the concave mirror 6 and subsequent passage through the beam splitter cube 10, these strike a path-folding mirror 11. At the path-folding mirror 11 the horizontal beam path is deflected along the optical axis 9, in turn, into a vertical optical axis 12. A third vertical objective part 1c with a further lens group 13 is located below the path-folding mirror 11. In addition, three λ/4 plates 14, 15 and 16 are also located in the beam path. The λ/4 plate 14 is located in the projection lens 1 between the reticle 3 and the beam splitter cube 10 downstream of a lens or lens group 17. The λ/4 plate 15 is located in the beam path of the horizontal objective part 1b, and the λ/4 plate 16 is located in a third objective part 1c. The three λ/4 plates 14, 15 and 16 serve the purpose of completely rotating the polarization once, as a result of which, inter alia, beam losses are minimized.

The beam splitter cube 10 deflects the light beam coming from the reticle 3 into the extension arm with the concave mirror 6, the light beam returning from the extension arm being passed straight through the beam splitter cube 10. In order for the light beam to be deflected from the reticle beam path exactly onto the optical axis 9 of the extension beam path, the beam splitter layer plane 18 has to run exactly at the point of intersection 19 of the optical axes of the reticle beam and extension arm beam (8 and 9). In addition, the normal to the beam splitter layer plane 18 must be inclined at half the angle which is enclosed by the optical axes 8 and 9 of the reticle beam path and extension arm beam path to the optical axis from the reticle beam path 8 and to the optical axis of the extension arm beam path 9.

A portion of the light which passes through the beam splitter cube 10 is absorbed by the beam splitter cube 10 and leads to heating of the beam splitter cube 10. Owing to the thermal expansion of the beam splitter cube material, the beam splitter plane 18 can be tilted and displaced and even be itself deformed, as a result of which errors occur in the imaging of the projection lens 1. These aberrations can be partially compensated by a specific tilting of the beam splitter cube 10 as a function of the thermal deformation of the beam splitter cube 10.

Again, the compensation of aberrations which are caused by heating when light passes through other optical elements of the projection lens 1 would be possible by specifically tilting the beam splitter cube 10 as a function of thermal expansion.

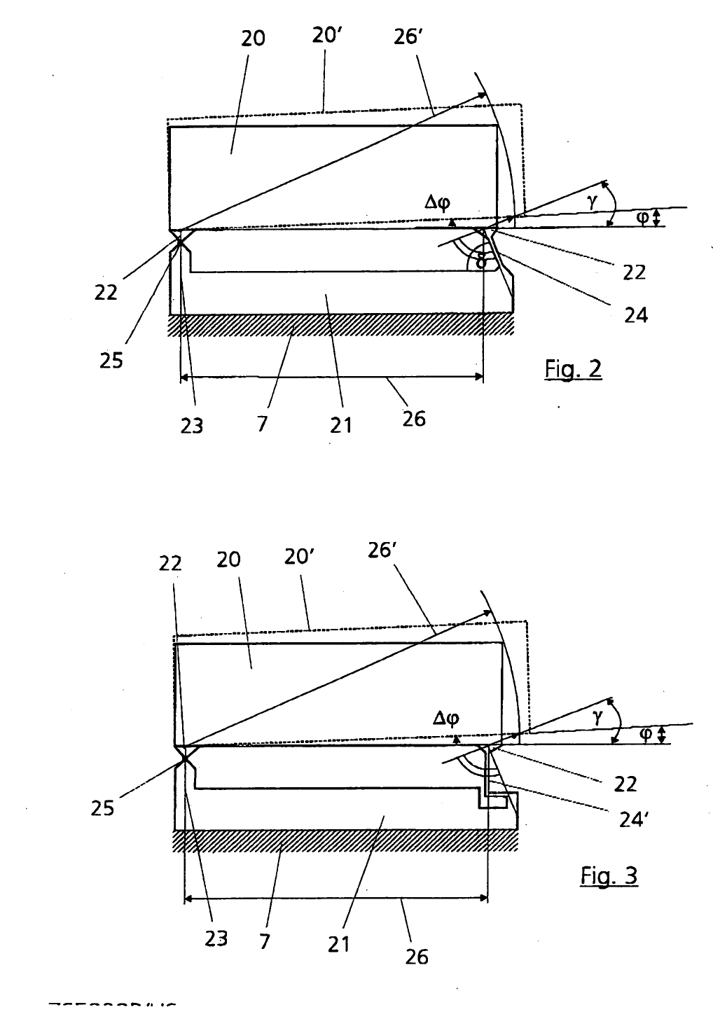

A bearing arrangement for thermal tilting correction of an optical element 20, for example the beam splitter cube 10 or else a mirror, will be described below in very general terms with the aid of FIG. 2. The optical element 20 is connected to the lens housing 7, for example, via a mount 21. The contact surfaces 22 of the mount 21 with the optical element 20 are elastically connected via solid joints, advantageously spring joints 23 and 24, to the part of the mount 21 which is fastened on the lens housing 7. The solid joints 23 and 24 are permanently connected to the optical element in the exemplary embodiment, for example by means of soldering, bonding or cementing.

It would also be possible for the optical element 20 to be mounted in an inner mount (not illustrated here), and for the solid joints 23 and 24 to connect the inner mount to the outer mount 21.

Whereas the spring joint 23 permits only a rotary movement perpendicular to the axis 25 (rotary movement perpendicular to the plane of the drawing), the spring joint 24 is fashioned such that the direction of its greatest elasticity encloses the angle γ with the long side of the optical element 20, which extends between the two solid joints 23 and 24 and on which the contact surfaces 22 are also seated.

Upon heating of the optical element 20, the length 26 of the underside lengthens to the length 26′, the guidance in the spring joint 24 during length compensation in relation to the mount 21 forcing the optical element 20 into the position 20′ which encloses the tilting angle φ relative to the original position. The magnitude of the tilting angle φ is prescribed in this case by the change in length from 26 to 26′, which is a function of the heating of the optical element 20.

The change in the tilting angle Δφ of the optical element 20 in relation to the mount 21 in the event of a temperature change ΔT is approximated roughly by:

Δφ=(α1−α2)/tanδ,

α₁ corresponding here to the coefficient of thermal expansion of the optical element 20, and α₂ to the coefficient of thermal expansion of the mount 21. The angle δ corresponds to the oblique position of the spring joint 24 relative to the mount 21. The equation confirms that the heating of the optical element 20 and of the mount 21 is correlated with the tilting angle φ, and this means that the optical element 20 expands all the more the larger the angle φ becomes. An automatic correction can now thereby be achieved.

A precondition for the tilting of the optical element 20 is the coefficients of thermal expansion α₁ of the optical element 20 and α₂ of the mount 21, which should be different, since the tilting movement is triggered by the relative change in length between the optical element 20 and the mount 21. The optical element 20, which can be produced, for example, from calcium fluoride, has a substantially larger coefficient of thermal expansion with reference to the mount 21.

The largest possible difference in the coefficients of thermal expansion of the optical element 20 and the mount 21 is advantageous in order to achieve the largest possible change in tilting angle Δφ over the change in temperature ΔT.

Depending on which material is selected for the optical element 20, and which material is selected for the mount 21, and by means of the geometry or the setting angle δ of the spring joint 24, the angle φ can be calculated exactly in advance so that the required tilting of the optical element 20 can be performed exactly. The changes in tilting angle Δφ vary in the range of a few milliradians and are scarcely perceptible with the naked eye.

If the optical element 20 is held by an inner mount, the material of the inner mount must have the same coefficient of thermal expansion as the optical element 20, while the coefficient of thermal expansion of the outer mount 21 should differ from that of the inner mount.

A further precondition for optimum tilting of the optical element 20 is that the tilting of the optical element 20 should be performed as far as possible without a time delay relative to the heating of the optical element 20, waiting for heating of the mount 21 appearing to be unfavourable for tilting correction. Should this not be possible under specific circumstances, the material of the mount part 21 in direct contact with the optical element 20 should be a good thermal conductor, in order to minimize the time delay.

The spring joints 23 and 24 are in one piece with the mount 21. This is advantageous, in turn, since only one material is required here for the spring joints 23 and 24 and for the mount 21, and this in turn leads to a simplified design of the arrangement.

FIG. 3 illustrates a further embodiment relating to the thermal tilting correction. In this examplary embodiment, the spring joint 24′ is fashioned in a different embodiment. The spring joints 23 and 24′ compensate the relative change in length through thermal expansion between the optical element 20 or the inner mount and the (outer) mount 21. The spring joints 23, 24′ should be deformed for this purpose. The forces which are required to deform the spring joints 23 and 24′ can be used with an appropriate configuration of the spring joint 24′ so that the spring joint 24′ compensates not only the relative change in length between the optical element 20 and the mount 21, but also effects a tilting movement of the optical element 20 relative to the mount 21.

The force compels at the spring joint 24′ not only a movement along the underside of the optical element 20, but also a displacement perpendicular to the underside, so that the optical element 20 is raised by the spring joint 24′ under the influence of the force and tilted into the position 20′. Here, as well, the tilting angle φ is prescribed by the heating of the optical element 20 by way of the equilibrant.

The coefficients of thermal expansion α₁ of the optical element 20 and α₂ of the mount 21 should likewise be different here, so as to render tilting of the optical element 20 possible. Likewise, the spring elements 23 and 24′ are connected here in one piece to the mount 21.

Since the design corresponds in principle to the exemplary embodiment 1 according to FIG. 2, the same reference numerals have also been used for identical paths in this exemplary embodiment.

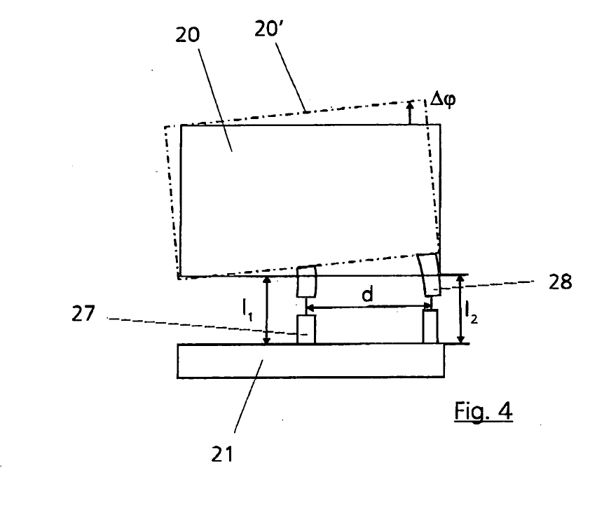

FIG. 4 shows a further embodiment, spring joints 27 and 28 being respectively permanently connected to the optical element 20 and the mount 21 by means of known connecting methods such as, for example, bonding. The spring joint 27 is arranged centrally between the optical element 20 and the mount 21, while the spring joint 28 is connected to the optical element 20 and the mount 21 at an outer side. The difference in the coefficients of thermal expansion α₃ and α₄ of the two spring joints 27 and 28 is a precondition for the optical element 20 to be capable of tilting here, as well. This means that the spring joint 27 should have a lower coefficient of thermal expansion than the spring joint 28 so that the optical element 20 can be tilted more strongly by the spring joint 28.

The change in the tilting angle Δφ of the optical element 20 by comparison with the mount 21 given the temperature change ΔT is here approximately:

Δφ/ΔT=(α₄l₂−α₃l₁)/d,

α₄ corresponding to the coefficient of thermal expansion of the spring joint 28, α₃ to the coefficient of thermal expansion of the spring joint 27, l₂ to the distance of the mount 21 from the optical element 20 at the location of the spring joint 28, and l₁ to the distance of the mount 21 from the optical element 20 at the location of the spring joint 27 and to the distance of the spring joint 27 from the spring joint 28.

So that a tilting of the optical element 20 can be achieved, at least one of the two spring joints 27 and/or 28 should assume the temperature of the optical element 20 as effectively as possible. In order to ensure there is no large time delay between the heating of the optical element 20 and the tilting, it is advantageous to produce at least one of the two spring joints 27 and/or 28 from a material which constitutes a good thermal conductor, and to connect it to the optical element 20 with good heat transfer.

It is also possible to tilt other optical elements as for example mirrors, lenses or bimirrors in a prismatic mode in a specific and heat strain dependent way, thus compensating aberrations.

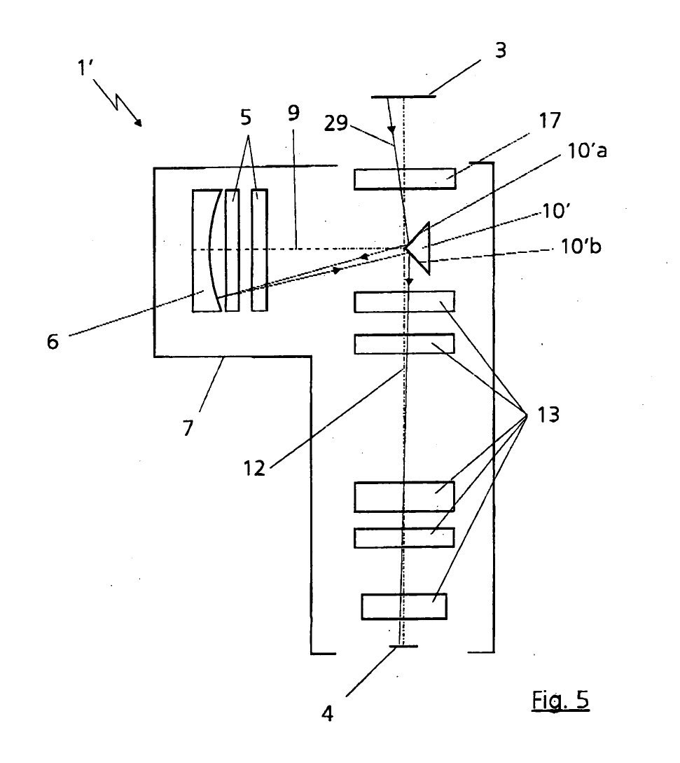

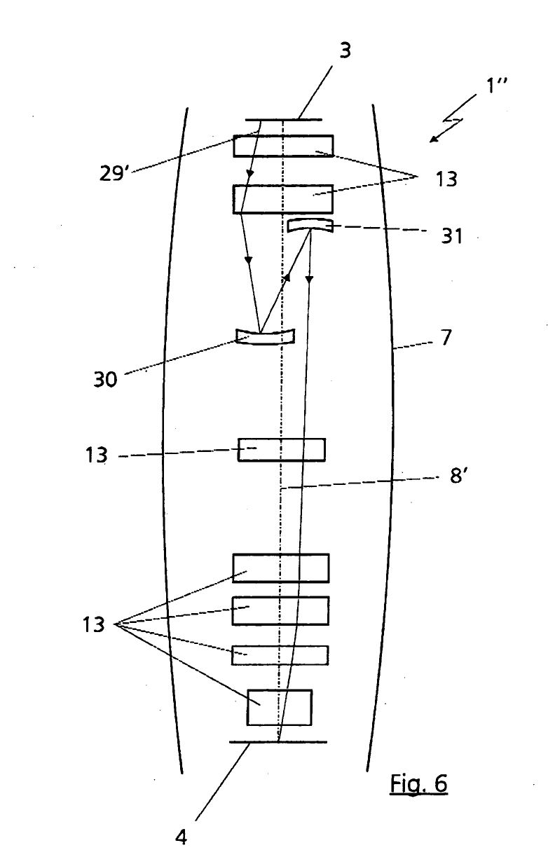

FIG. 5 shows an alternative projection lens 1′ in which the same parts as referred to FIG. 1 also have the same references. In comparison to FIG. 1, here, however, instead of the beam splitter cube 10 and the path-folding mirror 11, a bimirror 10′ or a prism is provided, which assumes the same function as the beam splitter cube 10 and the path-folding mirror 11 together. A projection beam 29 arising from reticle 3 and lens 17 is reflected in arrow direction at a first reflecting surface 10′a of the bimirror 10′ and is conducted to the concave mirror 6 along the horizontal optical axis 9. After reflection of the projection beam 29 at the concave mirror 6, the beam 29 is deflected at a reflecting surface 10′b of the bimirror 10′ in direction of the vertical optical axis 12.

The bimirror 10′, the concave mirror 6, and also the lens 17 for example, can be supported and tilted in a heat strain dependent way in the same manners as described under FIGS. 2, 3, and 4, so that arising aberrations can be compensated. Here, for example, the lens 17 and also lenses 13 can be supported in a mount and the latter can be supported by the described possibilities for thermal tilting correction.

In FIG. 6 a further alternative for designing a projection lens 1″ is shown, in which here also the same parts as referred to in FIG. 1 have the same references. A projection beam 29′ arising from reticle 3 is reflected at a first mirror 30 along an optical axis 8′ after passage through lenses or group of lenses 13 respectively. After reflection of the projection beam 29′ the latter is reflected again at a second mirror 31 and impinges through further lenses or groups of lenses 13 respectively on the wafer 4. Also here the mirrors 30 and 31 can be supported in a heat strain dependent way and tilted in such a manner that in doing so aberrations are reduced and compensated respectively.

What is claimed is:

1. Bearing arrangement comprising an optical element and a mount, wherein said optical element and said mount are connected to one another and a thermally induced expansion of said optical element or of said mount effects a tilting of said optical element relative to said mount.

2. Bearing arrangement comprising an optical element and a mount, wherein said optical element and said mount are connected to one another and a thermally induced expansion of said optical element and of said mount effects a tilting of said optical element relative to said mount.

3. Bearing arrangement according to claim 1 or 2, wherein said optical element and the mount have coefficients of thermal expansion which are fixed in such a way that tilting of said optical element relative to said mount is possible.

4. Bearing arrangement according to claim 1, wherein said optical element is connected to said mount via solid joints.

5. Bearing arrangement according to claim 2, wherein said optical element is connected to said mount via solid joints.

6. Bearing arrangement according to claim 4 or 5, wherein a first solid joint executes a rotary movement about an axis which is arranged perpendicular to an optical axis of the optical element, and with a second solid joint which executes a maximum movement enclosing an angle with a side of said optical element which extends between said two solid joints.

7. Bearing arrangement according to claim 4 or 5, wherein said solid joints are designed as spring joints.

8. Bearing arrangement according to claim 4 or 5, wherein said mount and said solid joints are of unipartite design, the coefficients of thermal expansion of said mount and of said solid joints having the same values.

9. Bearing arrangement according to claim 4 or 5, wherein said solid joints are permanently connected to said mount via connecting means, the coefficients of thermal expansion of said two solid joints having different values.

10. Bearing arrangement according to claim 1 or 2, wherein at least one of a group consisting of a lens, a mirror, a bimirror, a prism and a beam splitter element is provided as optical element.

11. The use of the bearing arrangement according to claim 1 or 2 in a projection lens in microlithography.
